(19) United States
(12) Patent Application Publication
(10) Pub. No.: US 2025/0317980 A1
(43) Pub. Date: Oct. 9, 2025

(54) IMPLICIT PHYSICAL RANDOM ACCESS CHANNEL ADAPTATION BASED ON PAGING

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 18/628,604

(22) Filed: Apr. 5, 2024

(51) Int. Cl. H04W 74/0833; H04W 68/02

(52) U.S. Cl. CPC H04W 74/0833; H04W 68/02

(57) ABSTRACT

The present disclosure provides techniques for wireless communications. A method includes receiving, from a network entity, a message comprising at least a physical random access channel (PRACH) configuration, where the PRACH configuration comprises a set of parameters for performing random access channel (RACH) procedures to establish connectivity with the network entity; monitoring for one or more paging-related indications, from the network entity, in one or more configured paging instances; determining to use the PRACH configuration or an adaptation PRACH configuration based at least in part on whether a paging-related indication is received; and performing a RACH procedure to establish connectivity with the network entity using the PRACH configuration or the adaptation PRACH configuration.

### BACKGROUND

### Field of the Disclosure

Aspects of the present disclosure relate to wireless communications, and more particularly, to techniques for adapting a physical random access channel (PRACH) configuration based on whether a paging-related indication is received.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes receiving, from a network entity, a message comprising at least a physical random access channel (PRACH) configuration, wherein the PRACH configuration comprises a first set of parameters for performing random access channel (RACH) procedures to establish connectivity with the network entity; monitoring for one or more paging-related indications, from the network entity, in one or more configured paging instances; determining to use the PRACH configuration or an adaptation PRACH configuration based at least in part on whether a paging-related indication is received; and performing a RACH procedure to establish connectivity with the network entity using the PRACH configuration or the adaptation PRACH configuration.

Another aspect provides a method for wireless communications by an apparatus. The method includes sending, to a device, a message comprising at least a PRACH configuration, wherein the PRACH configuration comprises a first set of parameters for the device to perform RACH procedures to establish connectivity with the apparatus; determining to indicate for the device to use the PRACH configuration or an adaptation PRACH configuration when sending a paging-related indication to the device; sending the paging-related indication, to the device, in at least one configured paging instance, wherein the paging-related indication indicates for the device to perform RACH procedures using the PRACH configuration or the adaptation PRACH configuration; and performing a RACH procedure to establish connectivity with the device using the PRACH configuration or the adaptation PRACH configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system.

FIG. 6 depicts an example adaptation for a physical random access channel (PRACH) configuration.

FIG. 7 depicts an example paging configuration.

FIG. 8 depicts a process flow for communications in a network between a network entity and a device.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for adapting a physical random access channel (PRACH) configuration based on whether a paging-related indication is received. In particular, certain aspects provide for a device to determine or to be indicated to use a PRACH configuration or an adaptation PRACH configuration for performing a random access channel (RACH) procedure based on whether a paging-related indication is received from a network entity prior to performing the RACH procedure (e.g., to establish a connection with the network entity). For example, if the device receives the paging-related indication, the device may determine or may be indicated to use the adaptation PRACH configuration to perform the RACH procedure. Additionally or alternatively, if the device receives the paging-related indication, the device may determine or may be indicated to use the PRACH configuration to perform the RACH procedure.

As described herein, the PRACH configuration may include a legacy PRACH configuration (e.g., a PRACH configuration that is configured for legacy devices, such as devices that are not configured for a current generation of wireless communications and that have less advanced circuitry and/or processing capabilities than devices configured for a current generation of wireless communications, but can be used by any device) or another type of PRACH configuration that is configured to be used by any device. Additionally or alternatively, the adaptation PRACH configuration may include a PRACH configuration that includes one or more PRACH adaptations that are applied and/or activated with respect to the PRACH configuration. For example, the PRACH configuration and the adaptation PRACH configuration may differ by one or more parameters (e.g., PRACH adaptations, PRACH adaptation parameters, etc.), such as a plurality of RACH occasions (ROs), a periodicity of the plurality of ROs, a number of synchronization blocks per RO of the plurality of ROs, a bitmap indicating one or more ROs of the plurality of ROs that are not to be used for RACH procedures (e.g., muted ROs), or a combination thereof.

As described herein, PRACH adaptation may be used to optimize a number of ROs (e.g., time-frequency resources configured for a device to perform a RACH procedure to establish a connection with a network entity) based on an identified need by a network entity. For example, a PRACH configuration may include a number of configured ROs, and the PRACH adaptation (e.g., the adaptation PRACH configuration) may include adjusting the number of configured ROs (e.g., increase or decrease the number of configured ROs) based on the identified need by the network entity.

In some aspects, a PRACH configuration may include a configuration of ROs with a small number of configured ROs, and the PRACH adaptation may dynamically add more ROs to the PRACH configuration based on an identified need by a network entity. For example, the identified need to increase a number of ROs may be caused by a greater number of devices entering a coverage area of the network entity, and the greater number of device may then attempt to perform respective RACH procedures to connect to the network entity. Thus, the increased number of ROs may reduce a chance that the respective RACH procedures interfere with each other and/or may provide more opportunities for the greater number of devices to perform the respective RACH procedures, thereby increasing a likelihood that the respective RACH procedures are successful. Additionally or alternatively, the identified need to increase the number of ROs may be caused by the network entity identifying an increase in downlink traffic to be sent to devices located in a coverage area of the network entity and/or an increase in expected uplink traffic from the devices. Accordingly, the increased number of ROs may increase a likelihood that the devices can successfully perform respective RACH procedures to then receive downlink messages from the network entity and/or send expected uplink messages to the network entity.

In some aspects, a PRACH configuration may include a configuration of ROs with a large number of configured ROs, and the PRACH adaptation may dynamically reduce and/or remove ROs (e.g., mute one or more configured ROs) based on an identified need by a network entity. For example, the identified need to reduce and/or remove a number of ROs may be caused by a decrease in a number of devices being in a coverage area of the network entity, such that the dense configuration of ROs is excessive or no longer needed for the decreased number of devices. Additionally or alternatively, the identified need to reduce and/or remove a number of ROs may be caused by the network entity identifying a decrease in downlink traffic to be sent to devices located in a coverage area of the network entity and/or a decrease in expected uplink traffic from the devices. Accordingly, in these described situations, the reduced and/or removed number of ROs may reduce signaling for the network entity and reduce a number of ROs that the network entity is expected to monitor.

In some aspects, the above described examples of adjusting a number of configured ROs may include adapting PRACH configurations in a time domain. For example, adapting the PRACH configuration may include increasing or reducing a periodicity of ROs, which may result in adjusting the number of configured ROs for a given time duration. That is, a higher periodicity may correspond to a higher number of configured ROs for the given time duration, and a lower periodicity may corresponding to a lower number of configured ROs for the given time duration.

Additionally or alternatively, adapting PRACH configurations may be performed in a spatial domain. In some aspects, the network entity may send synchronization signals to devices in a coverage area of the network entity, where the synchronization signals are sent via respective beams. The synchronization signals and corresponding beams may be associated with one or more respective ROs (e.g., ROs are mapped to the synchronization signals and/or corresponding beams), such that the device may determine which ROs to use for performing a RACH procedure based on which synchronizations signals are received and/or on which beams the synchronization signals are received. For example, a first set of synchronization signals may be sent via a first beam from the network entity, and the first set of synchronization signals and/or first beam may correspond to one or more first ROs, such that a device receiving the first set of synchronization signals via the first beam may determine to use the one or more first ROs to perform a RACH procedure to connect to the network entity.

Accordingly, the adaptation of PRACH configurations may include adding or removing one or more ROs and/or PRACH resources that are mapped to corresponding beamformed transmissions (e.g., beams carrying synchronization signals that correspond to ROs). For example, the network entity may adjust how many ROs or which ROs are mapped to the synchronization signals and/or corresponding beams. Subsequently, a device receiving the synchronization signals via the corresponding beams may determine to use the adjusted ROs mapped to those synchronization signals and/or beams to perform a RACH procedure to connect to the network entity.

In some aspects, the network entity may indicate a PRACH adaptation and/or adapt a PRACH configuration to add more ROs when more RACH attempts are expected to increase a likelihood that the expected RACH attempts are successful for the devices (e.g., provide more ROs to reduce a likelihood that the RACH attempts contend or interfere with each other). For example, the network entity may expect more RACH attempts (e.g., devices attempting to perform respective RACH procedures) when the network entity sends paging messages (e.g., paging-related indications) to the devices than when not sending paging messages. In some aspects, the network entity may send a paging message to devices for one or more reasons. For example, the one or more reasons may include determining downlink traffic has arrived to be sent to the devices, changing a system information message, or other purposes, where the paging message indicates for the devices to perform respective RACH procedures to connect to the network entity to subsequently receive the downlink traffic, receive the changed system information message, or for the other purposes.

Additionally or alternatively, the device may perform a RACH procedure without receiving a paging message (e.g., paging-related indication). For example, if uplink traffic arrives to be sent to the network entity, the device may perform a RACH procedure to establish connectivity with the network entity to then send the uplink traffic to the network entity (e.g., on uplink resources configured after the RACH procedure is successfully performed).

One or more technical problems arise when indicating one or more PRACH adaptations of a PRACH configuration. For example, a network entity may send a PRACH adaptation indication to one or more devices that are currently within a coverage area of the network entity (e.g., one or more devices that are camped on a cell of the network entity). However, sending the PRACH adaptation indication may include sending one or more downlink messages to the one or more devices, such as permanent equipment identifier (PEI) signaling, a DCI message (e.g., paging DCI), paging payload, RRC signaling, or another type of message not expressly listed herein, to explicitly indicate the one or more PRACH adaptations. In some aspects, these one or more downlink messages may include a higher signal complexity and/or may incur higher signal processing (e.g., for configuring and/or preparing the downlink messages at the network entity, as well as for receiving and/or decoding the downlink messages at the one or more devices) for explicitly indicating the one or more PRACH adaptations (e.g., compared to other available types of downlink signaling).

Accordingly, the techniques and signaling described herein provide a technical solution for a device to implicitly apply one or more PRACH adaptations to a PRACH configuration based on whether the device receives a paging-related indication from a network entity, where the paging-related indication may be considered a less complex type of signaling (e.g., includes a lower signal complexity and/or incurs reduced signal processing at the network entity to configure and prepare the paging-related indication and at the device to receive and decode the paging-related indication compared to other downlink messages that explicitly indicate the one or more PRACH adaptations). That is, the network entity may indicate (e.g., implicitly) for the device to apply the one or more PRACH adaptations based on sending a paging-related indication or not rather than sending the one or more downlink messages (e.g., that explicitly indicate the one or more PRACH adaptations). In some aspects, the paging-related indication may include a paging message (e.g., of certain contents), a paging early indication message, and/or a PEI indicating a paging message.

In some aspects, the network entity may initially send a message to the device, where the message may at least include a PRACH configuration that includes a set of parameters for performing RACH procedures (e.g., a legacy PRACH configuration as described previously or another type of PRACH configuration that is configured to be used by any device). Subsequently, the device may monitor for one or more paging-related indications from the network entity in one or more configured paging instances, and the device may determine to use the PRACH configuration or an adaptation PRACH configuration for performing at least one subsequent RACH procedure based on whether a paging-related indication is received or not in the one or more configured paging instances.

In some aspects, the PRACH configuration and the adaptation PRACH configuration may differ by one or more parameters (e.g., one or more PRACH adaptations, one or more PRACH adaptation parameters, etc.). For example, the adaptation PRACH configuration may include one or more PRACH adaptations that are activated and/or applied with respect to the PRACH configuration (e.g., as described previously). Subsequently, the device may determine or may be indicated to use the adaptation PRACH configuration and/or the one or more PRACH adaptations based on whether the paging-related indication is received or not.

In some aspects, the network entity may indicate an additional PRACH configuration in the message along with the first PRACH configuration, where the additional PRACH configuration includes the adaptation PRACH configuration. Additionally or alternatively, the network entity may indicate the PRACH configuration in the message, and the device may determine (e.g., derive) the adaptation PRACH configuration from the PRACH configuration. For example, the device may determine the adaptation PRACH configuration based on applying the one or more PRACH adaptations to the PRACH configuration. In some aspects, the device may determine or may be indicated to use the adaptation PRACH configuration based on receiving the paging-related indication. Alternatively, the device may determine or may be indicated to use the PRACH configuration based on receiving the paging-related indication.

In some aspects, in addition to being based on whether the paging-related indication is received or not, the device may determine to use the adaptation PRACH configuration based on being a certain device-type, supporting specific capabilities, being authorized by the network entity, being configured by the network entity, or a combination thereof. Additionally or alternatively, in addition to being based on any of the previous conditions described above, the device may determine to use the adaptation PRACH configuration based on receiving the paging-related indication in certain paging instances of the one or more configured paging instances (e.g., on certain paging occasions, in certain paging frames, in certain subgroups of the one or more configured paging instances, via certain beams, or a combination thereof).

In some aspects, the device may detect the paging-related indication and may determine the paging-related indication is not intended for the device (e.g., the paging-related indication is sent to or intended for another device). Accordingly, even if the paging-related indication is not intended for the device, the device may be allowed to apply the one or more PRACH adaptations and/or use the indicated additional PRACH configuration (or determine to use the PRACH configuration) based on detecting the paging-related indication. Additionally or alternatively, if the paging-related indication is not intended for the device, the device may not be allowed to apply the one or more PRACH adaptations and/or use the indicated additional PRACH configuration. Additionally or alternatively, if the paging-related indication is not intended for the device, the device may be allowed to apply the one or more PRACH adaptations and/or use the indicated additional PRACH configuration based on one or more conditions. For example, the one or more conditions may include a type of the device, one or more capabilities of the device, characteristics of uplink traffic to be sent by the device (e.g., a priority of the uplink traffic), or a combination thereof.

The techniques for implicitly indicating PRACH adaptation as described herein may provide any of various beneficial technical effects and/or advantages. For example, a network entity may save energy and/or reduce power consumption by indicating for a device to apply one or more PRACH adaptations based on sending a paging-related indication (e.g., paging message with certain contents, a paging early indication message, PEI indicating a paging message, etc.) to the device rather than sending one or more downlink messages that explicitly indicate the one or more PRACH adaptations. Additionally, the network entity may save energy by dynamically adapting PRACH configurations to reduce signaling overhead (e.g., reducing and/or muting one or more of ROs). Additionally or alternatively, the network entity may increase reliability for communications by dynamically adapting PRACH configurations to increase a number of available ROs (e.g., when more RACH attempts are expected, such as when sending a paging-related indication and/or paging message), where increasing the number of ROs may increase a likelihood that the devices can successfully perform respective RACH procedures.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

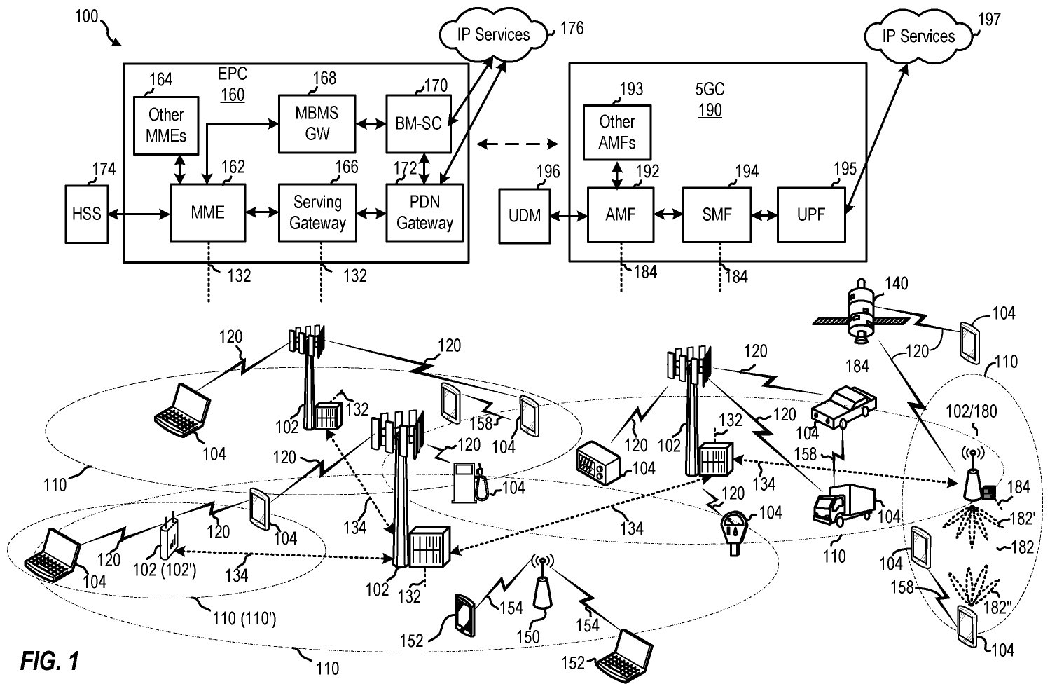

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects (also referred to herein as non-terrestrial network entities), such as ground-based network entities (e.g., BSs 102), and non-terrestrial aspects, such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

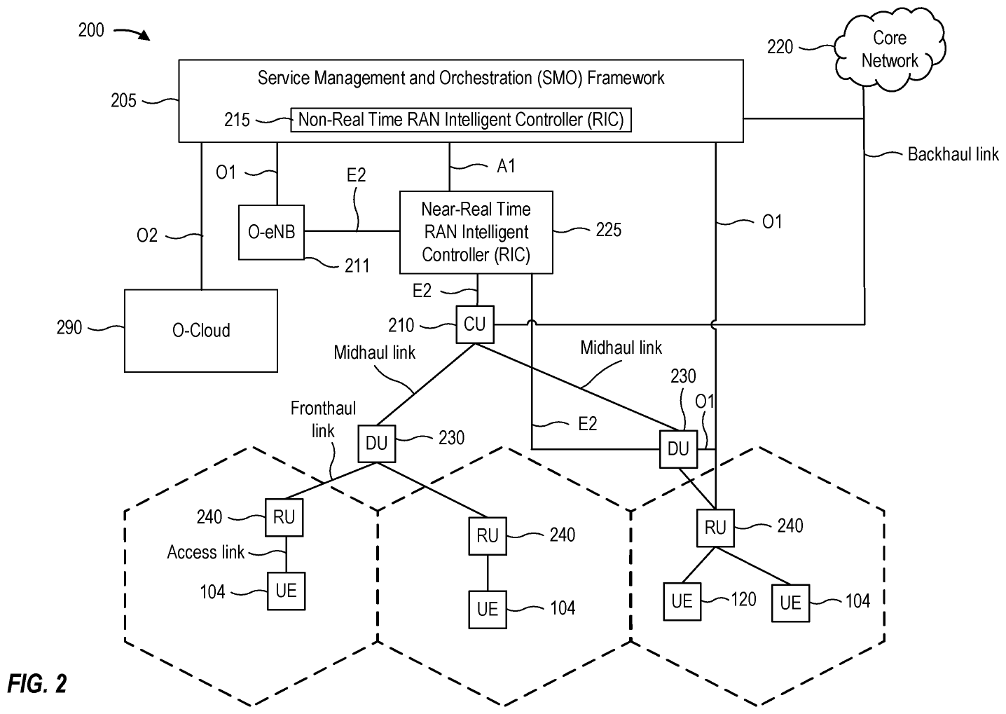

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

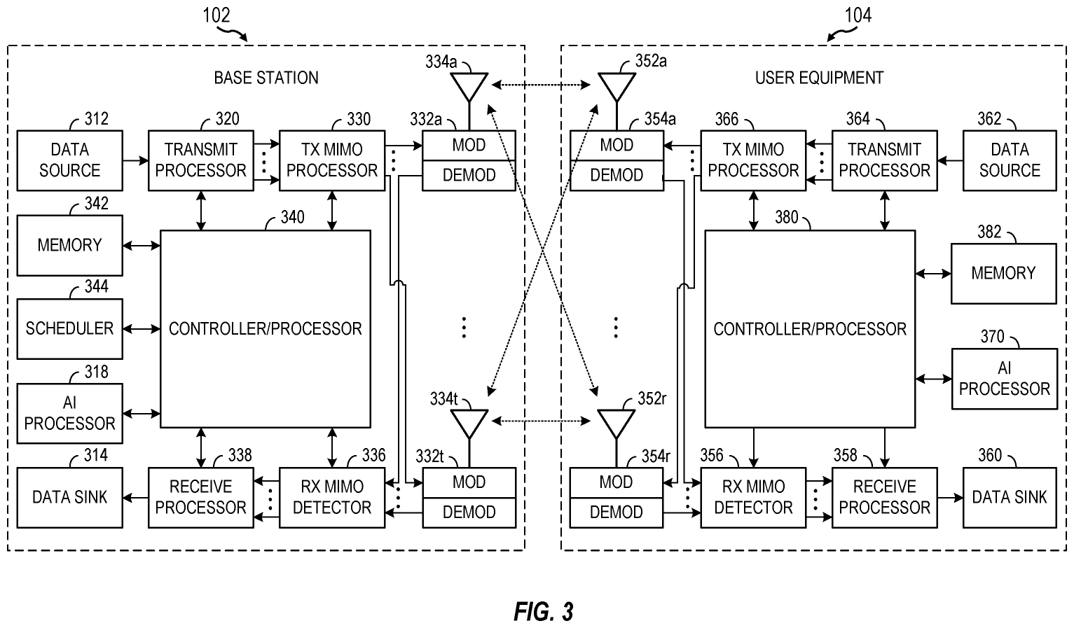

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

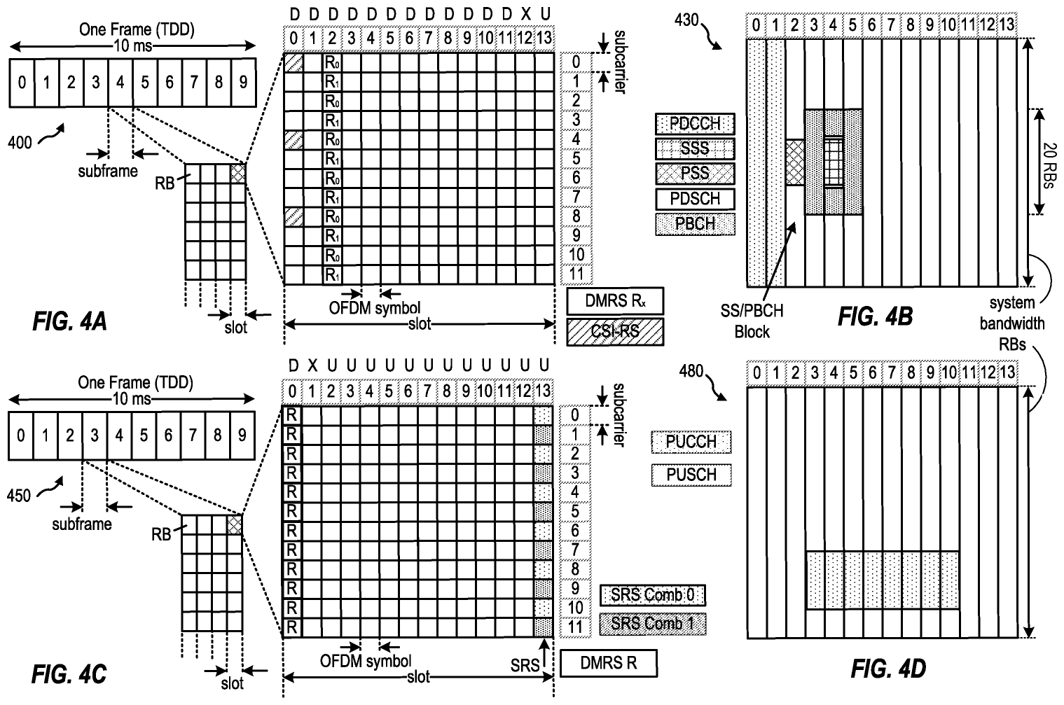

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Adapting a PRACH Configuration Based on Paging Signaling

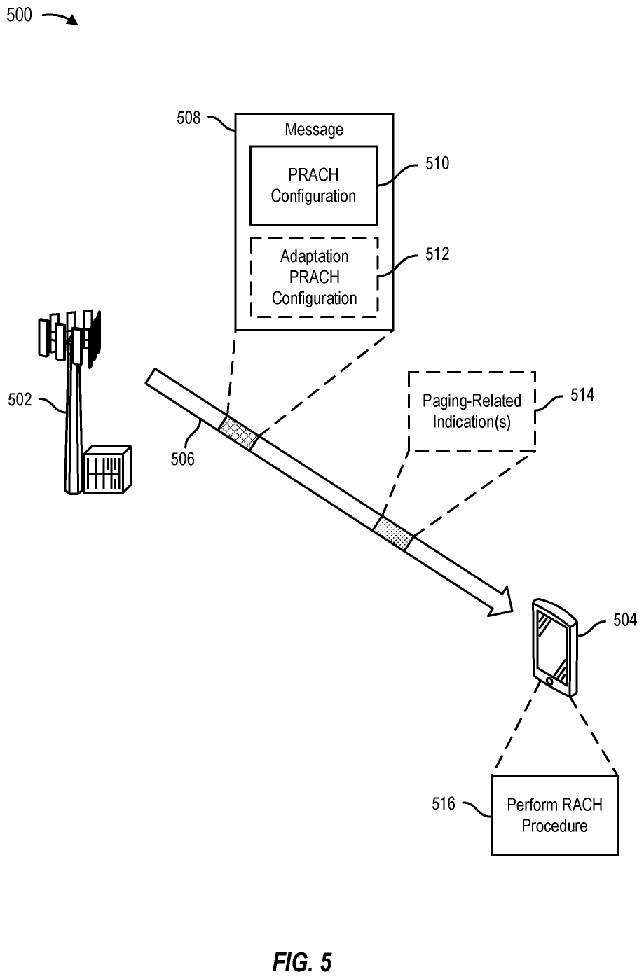

FIG. 5 depicts an example wireless communications system 500 for indicating an activation state for PRACH adaptation in accordance with aspects of the present disclosure. In some aspects, the wireless communications system 500 may implement aspects of or may be implemented by aspects of FIGS. 1-4D. For example, the wireless communications system 500 may include a network entity 502 and at least one device 504, where the network entity 502 may represent a base station or similar network entity as described with reference to FIGS. 1-3 and 12 (e.g., BS 102, BS 180, communications device 1200, etc.) and the device 504 may represent a UE or similar terminal device as described with reference to FIGS. 1-3 and 11 (e.g., UE 104, communications device 1100, etc.). Additionally, the network entity 502 and the device 504 may wirelessly communicate via a downlink communication link 506 (e.g., one or more carriers, a communication link 120, beamforming 182, etc.). While only one (1) device 504 is depicted in the example of FIG. 5, the network entity 502 may communicate with multiple devices.

In some aspects, the device 504 may perform a RACH procedure to request access to the network entity 502 to connect to the network entity 502 for a first time (e.g., initial access) or after a period of inactivity. For example, the device 504 may be configured to employ DRX operations to reduce power consumption and/or conserve battery of the device 504. In DRX, the device 504 may periodically alternate between an active mode (e.g., “ON” or awake periods) during DRX-on cycles and an inactive mode (e.g., “OFF,” sleep periods, or idle periods). During the active mode and the DRX-on cycles, the device 504 may power on at least a portion of its internal circuitry to monitor for messages or incoming data. Additionally or alternatively, in the inactive mode, the device 504 may power down at least a portion of its internal circuitry to reduce power consumption (e.g., battery power consumption), and the device 504 is not expected to receive messages or data in the inactive mode.

In some aspects, the device 504 may attempt to perform a RACH procedure when in the active mode of DRX based on whether the network entity 502 indicates there is downlink traffic for the device 504 to receive during the active mode and/or uplink traffic arrives while the device 504 is in the active mode. Additionally or alternatively, the device 504 may attempt to perform a RACH procedure when in the inactive mode (e.g., the device 504 is idle) based on an arrival of uplink traffic to send to the network entity 502 and/or in certain cases of paging, such as downlink data arrival.

The RACH procedure may be a four-step RACH procedure or a two-step RACH procedure. In the four-step RACH procedure, the device 504 may select (e.g., for contention-based random access (CBRA)) or may be configured with (e.g., for contention-free random access (CFRA)) a RACH preamble from a group of available preambles (e.g., indicated by the network entity 502 in an SSB, SIB, or RRC configuration message) and may send a first RACH message (e.g., msg1) to the network entity 502 (e.g., via configured PRACH resources) that includes the RACH preamble. The network entity 502 may then send a second RACH message (e.g., msg2) to the device 504 within a RACH response window, where the second RACH message includes a RACH response and one or more parameters for subsequent communications (e.g., the RACH preamble to indicate the second RACH message is intended for the device 504, timing alignment information, an initial uplink grant, a cell radio network temporary identifier (C-RNTI, etc.). The device 504 may then send a third RACH message (e.g., msg3) that includes uplink scheduling information based on receiving the second RACH message. The network entity 502 may then send a fourth RACH message (e.g., msg4) to the device 504 before a contention resolution timer expires for contention resolution (e.g., if multiple devices select a same RACH preamble for the first RACH message). If the device 504 receives the fourth RACH message from the network entity 502, the device 504 may determine the four-step RACH procedure was successful, and the device 504 may enter a connected state with the network entity 502 for enabling subsequent communications.

In the two-step RACH procedure, the device 504 may send a first RACH message (e.g., msgA) that includes the contents of the first RACH message (e.g., msg1) and the third RACH message (e.g., msg3) as described above with reference to the four-step RACH procedure. The network entity 502 may then send a second RACH message (e.g., msgB) that includes the contents of the second RACH message (e.g., msg2) and the fourth RACH message (e.g., msg4) as described above with reference to the four-step RACH procedure. If the device 504 receives the second RACH message from the network entity 502, the device 504 may determine the two-step RACH procedure was successful, and the device 504 may enter a connected state with the network entity 502 for enabling subsequent communications.

In some aspects, prior to performing a RACH procedure (e.g., the four-step RACH procedure or the two-step RACH procedure), the network entity 502 may send a PRACH configuration to the network entity 502 (e.g., via a SIB, such as a SIB1; RRC configuration message; etc.). The PRACH configuration may include parameters for enabling the device 504 to perform the RACH procedure, such as RACH preambles for the device 504 to select from, an indication of ROs where the device 504 can perform the RACH procedure (e.g., time-frequency resources for performing the RACH procedure), a mapping of SSBs to the ROs, information for the RACH response window, information for the contention resolution timer, etc.

In some aspects, the PRACH configuration may be static (e.g., the parameters remain unchanged), or the network entity 502 may update one or more PRACH parameters in the PRACH configuration. For example, PRACH adaptation may be used to update the one or more PRACH parameters of the PRACH configuration. In some aspects, the network entity 502 may indicate the PRACH adaptation using one or more downlink messages that include a higher signal complexity and/or higher signal processing for explicitly indicating the PRACH adaptations (e.g., compared to other available types of downlink signaling).

As described herein, to reduce signaling complexity and reduce signal processing, the network entity 502 may implicitly indicate for the device 504 to apply one or more PRACH adaptations based on sending a paging-related indication rather than sending the one or more downlink messages (e.g., that explicitly indicate the one or more PRACH adaptations). In some aspects, the paging-related indication may include paging message with a DCI message with a format 1_0 that includes a cyclic redundancy check (CRC) scrambled by a paging radio network temporary identifier (P-RNTI). The DCI message with a format 1_0 may include an indicator (e.g., short message indicator) to indicate if the DCI message includes scheduling information for a paging message or not, a short message (e.g., to indicate one or more system information modifications, a public warning system indication, to stop monitoring a paging occasion, etc.), frequency-domain and time-domain resource assignments for the paging message, resource block mapping information, a modulation and coding scheme (MCS) for the paging message, transport block (TB) scaling information, a tracking reference signal (TRS) availability indication, or a combination thereof. Additionally or alternatively, the paging-related indication may include a paging message with certain contents, a paging early indication message, and/or a PEI indicating a paging message.

As shown in the example of FIG. 5, the network entity 502 may initially send a message 508 to the device 504, where the message 508 may at least include a PRACH configuration 510 that includes a set of parameters for performing RACH procedures (e.g., a legacy PRACH configuration as described previously or another type of PRACH configuration that is configured to be used by any device). For example, the message 508 may be a system information message (e.g., a SIB, a SIB1, another SIB, or another type of system information message) or an RRC message. In some aspects, the device 504 may monitor for one or more paging-related indications 514 from the network entity 502 in one or more configured paging instances. Subsequently, the device 504 may determine to use the PRACH configuration 510 or an adaptation PRACH configuration 512 for performing at least one subsequent RACH procedure 516 (e.g., four-step RACH procedure or two-step RACH procedure) based on whether a paging-related indication 514 is received in the one or more configured paging instances. In some aspects, the device 504 may determine to perform the at least one subsequent RACH procedure 516 using the PRACH configuration 510 to establish connectivity with the network entity 502 (e.g., without receiving a paging-related indication 514) for sending uplink traffic to the network entity 502.

In some aspects, the PRACH configuration 510 and the adaptation PRACH configuration 512 may differ by one or more parameters (e.g., one or more PRACH adaptations, one or more PRACH adaptation parameters, etc.). For example, the adaptation PRACH configuration 512 may include one or more PRACH adaptations applied with respect to the PRACH configuration 510, where the adaptation PRACH configuration 512 and/or the one or more PRACH adaptations are activated and/or applied for the device 504 based on whether the paging-related indication 514 is received or not. As described previously, the one or more PRACH adaptations may include increasing or decreasing a number of ROs, increasing or decreasing a periodicity of the ROs, adjusting one or more ROs mapped to SSBs and/or beams, increasing or decreasing a number of SSBs configured per RO (e.g., could be different per SSB), muting one or more ROs, etc., with respect to the PRACH configuration 510. In some aspects, the network entity may indicate the muting of one or more ROs in the message 508 or in an additional message (e.g., additional system information message, additional RRC message, etc.) via a bitmap. For example, the bitmap may include a plurality of index values (e.g., bit strings), where each index value corresponds to different configurations of which ROs are muted. Additionally or alternatively, the PRACH configuration 510 and the adaptation PRACH configuration 512 may include one or more common parameters.

In some aspects, the network entity 502 may indicate an additional PRACH configuration in the message 508, where the additional PRACH configuration includes the adaptation PRACH configuration 512. Additionally or alternatively, the network entity may indicate the PRACH configuration 510 in the message 508, and the device 504 may determine (e.g., derive) the adaptation PRACH configuration 512 from the PRACH configuration 510 based on activating and/or applying one or more PRACH adaptations to the PRACH configuration 510. In some aspects, the network entity 502 may indicate the one or more PRACH adaptations to the device 504 in the message 508 or in an additional message (e.g., an additional system information message or additional RRC message). Accordingly, based on whether the paging-related indication 514 is received or not, the device 504 may then determine the adaptation PRACH configuration 512 based on applying the one or more PRACH adaptations to the PRACH configuration 510 for performing the at least one subsequent RACH procedure 516.

In some aspects, if the device 504 receives the paging-related indication 514, the device 504 may determine or may be indicated to use the adaptation PRACH configuration 512 to perform the at least one subsequent RACH procedure 516. In some aspects, the adaptation PRACH configuration 512 may include one or more PRACH adaptations that correspond to a higher number of ROs than the PRACH configuration 510 (e.g., such as more ROs, a higher periodicity of ROs, etc.). Accordingly, the network entity may indicate for the device 504 to use the adaptation PRACH configuration 512 when receiving the paging-related indication 514 for scenarios where more ROs are desired (e.g., expecting more RACH attempts, such as when sending paging-related indications to devices to indicate upcoming downlink traffic and/or that a system information message is changed). Additionally or alternatively, when the adaptation PRACH configuration 512 includes a higher number of ROs than the PRACH configuration 510 and if fewer ROs are needed (e.g., fewer RACH attempts are expected, such as when fewer devices are located in a coverage area or cell of the network entity), the network entity 502 may refrain from sending the paging-related indication 514, resulting in the device 504 using the PRACH configuration 510.

Additionally or alternatively, the adaptation PRACH configuration 512 may include one or more PRACH adaptations that correspond to a lower number of ROs than the PRACH configuration 510 (e.g., fewer ROs, a lower periodicity of ROs, and/or one or more muted ROs). Accordingly, the network entity 502 may send the paging-related indication 514 to indicate for the device 504 to use the adaptation PRACH configuration 512 for performing the at least one subsequent RACH procedure 516 when fewer ROs are needed. Additionally or alternatively, when the adaptation PRACH configuration 512 includes a lower number of ROs than the PRACH configuration 510 and if more ROs are needed, the network entity 502 may refrain from sending the paging-related indication 514, resulting in the device 504 using the PRACH configuration 510.

In some aspects, if the device 504 receives the paging-related indication 514, the device 504 may determine or may be indicated to use the PRACH configuration 510 to perform the at least one subsequent RACH procedure 516. In some aspects, the PRACH configuration 510 may include a higher number of ROs than the adaptation PRACH configuration 512 (e.g., the adaptation PRACH configuration 512 includes one or more PRACH adaptations that correspond to a lower number of ROs than the PRACH configuration 510 as described previously). Accordingly, the network entity 502 may send the paging-related indication 514 to indicate for the device 504 to use the PRACH configuration 510 for performing the at least one subsequent RACH procedure 516 when more ROs are needed (e.g., a high number of RACH attempts are expected). Additionally or alternatively, when the PRACH configuration 510 includes a higher number of ROs than the adaptation PRACH configuration 512 and if fewer ROs are needed (e.g., a low number of RACH attempts are expected), the network entity 502 may refrain from sending the paging-related indication 514, resulting in the device 504 using the adaptation PRACH configuration 512.

Additionally or alternatively, the PRACH configuration 510 may include a lower number of ROs than the adaptation PRACH configuration 512 (e.g., the adaptation PRACH configuration 512 includes one or more PRACH adaptations that correspond to a higher number of ROs than the PRACH configuration 510 as described previously). Accordingly, the network entity 502 may send the paging-related indication 514 to indicate for the device 504 to use the PRACH configuration 510 for performing the at least one subsequent RACH procedure 516 when fewer ROs are needed. Additionally or alternatively, when the PRACH configuration 510 includes a lower number of ROs than the adaptation PRACH configuration 512 and if more ROs are needed, the network entity 502 may refrain from sending the paging-related indication 514, resulting in the device 504 using the adaptation PRACH configuration 512.

In some aspects, the parameters by which the PRACH configuration 510 and the adaptation PRACH configuration 512 differ (e.g., the one or more PRACH adaptations) may be left to network implementation (e.g., a determination made by the network entity 502), such that which PRACH configuration is activated and/or applied when sending the paging-related indication 514 may also be left to network implementation. For example, in the above described examples, the network entity 502 may determine which PRACH configuration to activate and/or apply for the device 504 when sending the paging-related indication 514 based on how many ROs are configured for each PRACH configuration and how many ROs are needed or desired (e.g., for expected RACH attempts).

Additionally or alternatively, the PRACH configuration 510 and the adaptation PRACH configuration 512 may differ by one or more PRACH adaptations in addition to or other than an increased or reduced number of ROs. For example, certain ROs may differ between the PRACH configuration 510 and the adaptation PRACH configuration 512, and/or the PRACH configuration 510 and the adaptation PRACH configuration 512 may differ by which ROs are mapped to which synchronization signals and/or beams. Subsequently, the network entity 502 may determine which PRACH configuration to activate and/or apply for the device 504 when sending the paging-related indication 514 for other situations (e.g., situations other than when more or fewer ROs are needed or desired) and then may accordingly send the paging-related indication 514 to indicate to the device 504 to activate and/or apply the determined PRACH configuration.

In some aspects, the network entity 502 may determine that certain ROs and/or corresponding beams (e.g., beams to which the certain ROs are mapped) are more efficient for the device 504 to use for performing the at least one subsequent RACH procedure 516 (e.g., less contested ROs, beams directed more precisely towards the device 504, beams with higher signal power and/or better signal quality, etc.). Subsequently, the network entity 502 may determine that the certain ROs and/or corresponding beams correspond to the PRACH configuration 510 or the adaptation PRACH configuration 512. Accordingly, the network entity 502 may determine which PRACH configuration to activate and/or apply for the devices when sending the paging-related indication based on which PRACH configuration is determined to correspond to the certain ROs and/or corresponding beams.

For example, if the PRACH configuration 510 is determined to correspond to the certain ROs and/or corresponding beams, the network entity 502 may indicate for the device 504 to use the PRACH configuration 510 to perform the at least one subsequent RACH procedure 516 by sending the paging-related indication 514 (e.g., if the device 504 is configured to activate the PRACH configuration 510 when the paging-related indication 514 is received) or by refraining from sending the paging-related indication 514 (e.g., if the device 504 is configured to activate the adaptation PRACH configuration 512 when the paging-related indication 514 is received). Additionally or alternatively, if the adaptation PRACH configuration 512 is determined to correspond to the certain ROs and/or corresponding beams, the network entity 502 may indicate for the device 504 to use the adaptation PRACH configuration 512 to perform the at least one subsequent RACH procedure 516 by sending the paging-related indication 514 (e.g., if the device 504 is configured to activate the adaptation PRACH configuration 512 when the paging-related indication 514 is received) or by refraining from sending the paging-related indication 514 (e.g., if the device 504 is configured to activate the PRACH configuration 510 when the paging-related indication 514 is received).

In some aspects, the device 504 may conditionally use the adaptation PRACH configuration 512 to perform the at least one subsequent RACH procedure 516 based on whether the paging-related indication 514 is received. For example, devices of a specific type (e.g., reduced capability (RedCap) devices) or devices supporting specific capabilities (e.g., network energy savings (NES)-capable devices) may use the adaptation PRACH configuration 512 based on whether the paging-related indication 514 is received. Additionally or alternatively, devices that have been authorized and/or configured by the network entity 502 may use the adaptation PRACH configuration 512 based on whether the paging-related indication 514 is received. Additionally or alternatively, any device may use the adaptation PRACH configuration 512 based on whether the paging-related indication 514 is received. In some aspects, the network entity 502 may indicate the conditions (e.g., for which device(s) can use the adaptation PRACH configuration 512 based on whether the paging-related indication 514 is received) in a system information message (e.g., SIB, SIB1, RRC message, etc.) or the conditions may be fixed (e.g., defined in wireless standards).

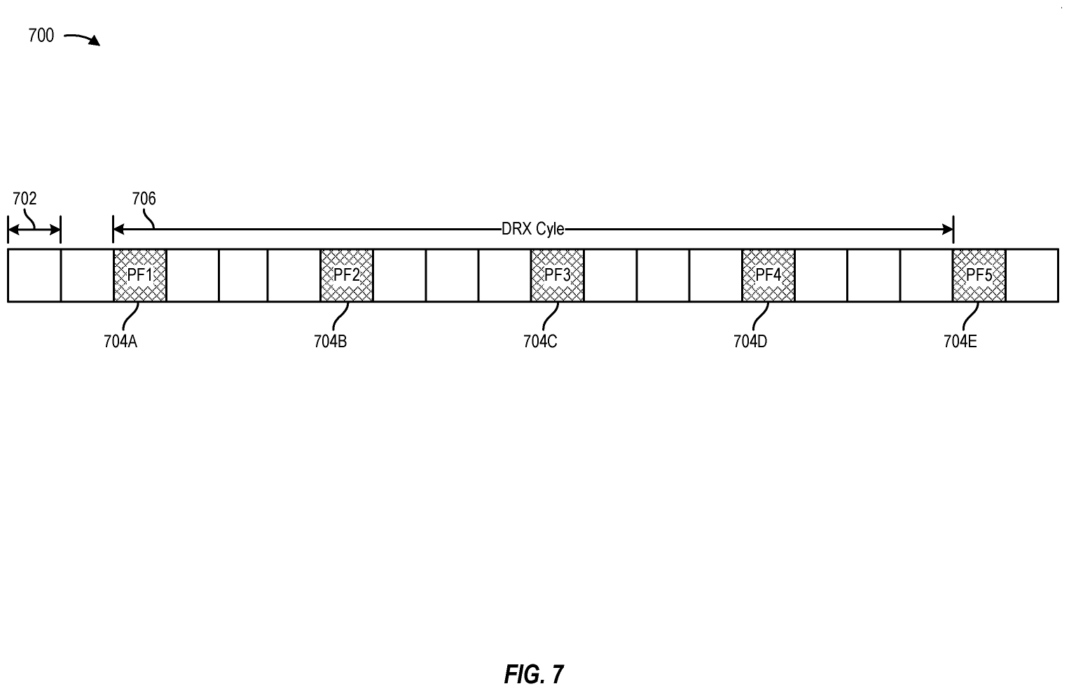

Additionally or alternatively, the device 504 may conditionally determine which PRACH configuration to use based on receiving the paging-related indication 514 in certain paging instance(s) of the one or more configured paging instances. For example, the device 504 may determine to use the adaptation PRACH configuration 512 based on receiving the paging-related indication 514 on certain paging occasions, in certain paging frames, in certain subgroups of the one or more configured paging instances, via certain beams, or a combination thereof. In some aspects, the network entity 502 may indicate the certain paging instance(s) to the device 504 in a system information message (e.g., SIB, SIB1, RRC message, etc.) or the certain paging instance(s) may be fixed (e.g., defined in wireless standards). The condition of determining which PRACH configuration to use based on receiving the paging-related indication 514 in certain paging instance(s) of the one or more configured paging instances is described in greater detail with FIG. 7.

In some aspects, the device 504 may detect the paging-related indication 514 and may determine the paging-related indication 514 is not intended for the device 504 (e.g., the paging-related indication 514 includes information indicating the paging-related indication was sent to or intended for another device). Accordingly, even if the paging-related indication 514 is not intended for the device 504, the device 504 may be allowed to use the adaptation PRACH configuration 512 based on detecting the paging-related indication 514. Additionally or alternatively, if the paging-related indication 514 is not intended for the device 504, the device 504 may not be allowed to use the adaptation PRACH configuration 512. Additionally or alternatively, if the paging-related indication 514 is not intended for the device 504, the device 504 may be allowed to use the adaptation PRACH configuration 512 based on one or more conditions. For example, the one or more conditions may include a type of the device 504, one or more capabilities of the device 504, characteristics of uplink traffic to be sent by the device 504 (e.g., a priority of the uplink traffic), or a combination thereof. In some aspects, the network entity 502 may indicate the one or more conditions in a system information message (e.g., SIB, SIB1, RRC message, etc.) or the one or more conditions may be fixed (e.g., defined in wireless standards).

### Aspects Related to Implicit PRACH Adaptation

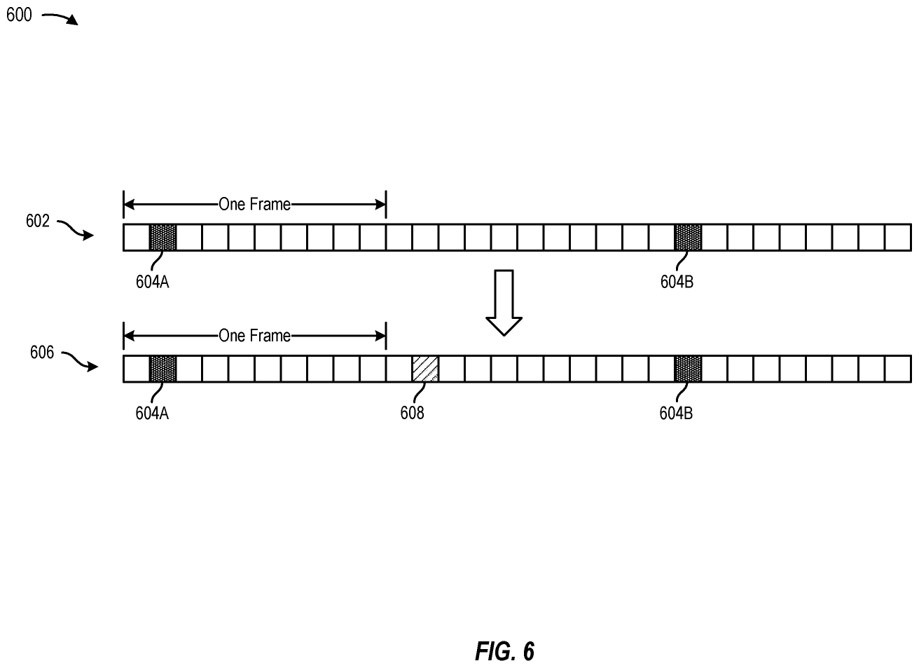

FIG. 6 depicts an example adaptation 600 for a PRACH configuration in accordance with aspects of the present disclosure. In some aspects, the adaptation 600 for a PRACH configuration may implement aspects of or may be implemented by aspects of FIGS. 1-5 and 11-12. For example, the adaptation 600 may represent a PRACH adaptation as described with reference to FIG. 5, where a network entity (e.g., BS 102, BS 180, network entity 502, communications device 1200, etc.) may implicitly indicate the PRACH adaptation to one or more devices (e.g., UE 104, device 504, communications device 1100, etc.) based on signaling a paging-related indication to the one or more devices.

In the example of FIG. 6, a PRACH configuration 602 (e.g., the PRACH configuration 510 as described with reference to FIG. 5) may include one or more ROs 604 with a first periodicity. In some aspects, the PRACH configuration 602 may include at least a first RO 604A and a second RO 604B, where the first RO 604A and the second RO 604B are separated in the time-domain according to the first periodicity. For example, as shown in the example of FIG. 6, the first periodicity may be 20 ms, and the first RO 604A and the second RO 604B may be separated by 20 ms (e.g., 20 subframes, where each subframe has a duration of 1 ms, and one frame includes 10 subframes).

In some aspects, the network entity may indicate, to the one or more devices, one or more PRACH adaptations are activated (e.g., the one or more PRACH adaptations are applied to the PRACH configuration 602), such as by sending a paging-related indication as described with reference to FIG. 5. Subsequently, the one or more devices may determine and/or use an adaptation PRACH configuration 606 (e.g., the adaptation PRACH configuration 512 as described with reference to FIG. 5) to perform RACH procedures, where the adaptation PRACH configuration 606 includes the one or more activated PRACH adaptations. For example, the one or more PRACH adaptations may include a second periodicity for the adaptation PRACH configuration 606, where the second periodicity is different than the first periodicity configured for the PRACH configuration 602.

Based on the second periodicity, the adaptation PRACH configuration 606 may include at least one additional RO, such as an additional RO 608, compared to the PRACH configuration 602. In the example of FIG. 6, the second periodicity configured for the adaptation PRACH configuration 606 may be 10 ms, such that the first RO 604A and the additional RO 608 are separated by 10 ms (e.g., 10 subframes) and the additional RO 608 and the second RO 604B are also separated by 10 ms.

FIG. 7 depicts an example paging configuration 700 in accordance with aspects of the present disclosure. In some aspects, the paging configuration 700 may implement aspects of or may be implemented by aspects of FIGS. 1-6 and 11-12. For example, the paging configuration 700 may be used for indicating a PRACH adaptation as described with reference to FIG. 5, where a network entity (e.g., BS 102, BS 180, network entity 502, communications device 1200, etc.) may implicitly indicate the PRACH adaptation to one or more devices (e.g., UE 104, device 504, communications device 1100, etc.) based on signaling a paging-related indication to the one or more devices according to the paging configuration 700.

In some aspects, the paging configuration 700 may include a plurality of frames 702. Additionally, the paging configuration 700 may include one or more paging frames 704, such as a first paging frame 704A, a second paging frame 704B, a third paging frame 704C, a fourth paging frame 704D, and a fifth paging frame 704E. In some aspects, the first paging frame 704A, the second paging frame 704B, the third paging frame 704C, and the fourth paging frame 704D may be part of a DRX cycle 706. For example, the DRX cycle 706 may be configured with a time duration (e.g., 16 frames, where each frame has a duration of 10 ms, resulting in a total time duration of 160 ms) and with four (4) paging frames per cycle. In some aspects, a system frame number (SFN) for each paging frame (PF) may be given by Equation 1 below:

$$( S F N + P {F}_{offset} ) mod T = \frac{T}{N} ( UEID mod N ) \qquad ( 1 )$$

where PF_{offset} may represent a configured offset value for a first configured paging frame in the DRX cycle 706, T may represent the time duration of the DRX cycle 706, N may represent the number of paging frames configured per cycle, and UEID may represent an ID for the device configured to perform DRX using the DRX cycle 706.

Each paging frame 704 may include one or more paging occasions, as described herein, for the one or more devices to monitor for paging-related indications from the network entity (e.g., a paging message, a paging message with certain contents, a paging early indication message, a PEI indicating a paging message, etc.). Index values for each paging occasion in a paging frame 704 may be given by Equation 2 below:

$${i}_{s} = floor ( \frac{UEID}{N} ) mod {N}_{s} ) \qquad ( 2 )$$

where iₛ may represent a paging occasion index value for an ‘s’ paging frame, where s is an integer; and Nₛ may represent a number corresponding to the ‘s’ paging frame (e.g., N₁ may represent the first paging frame 704A and may have a value of 1, N₂ may represent the second paging frame 704B and have a value of 2, etc.). In some aspects, the one or more paging frames 704 and/or a total number of paging occasions from the one or more paging frames 704 may be considered the one or more configured paging instances (e.g., as described with reference to FIG. 5) that the device uses to monitor for one or more paging-related indications.

As described previously, the device may determine whether to apply one or more PRACH adaptations and/or use an indicated PRACH configuration (e.g., the adaptation PRACH configuration 512 as described with reference to FIG. 5) based on receiving a paging-related indication in certain paging instances of the one or more configured paging instances (e.g., on certain paging occasions, in certain paging frames, in certain subgroups of the one or more configured paging instances, via certain beams, or a combination thereof). Additionally, as described previously, the network entity may indicate the certain paging instance(s) to the device in a system information message (e.g., SIB, SIB1, RRC message, etc.) or the certain paging instance(s) may be fixed (e.g., defined in wireless standards).

As an example, the device may apply the one or more PRACH adaptations and/or use the indicated PRACH configuration based on receiving the paging-related indication in even-numbered paging instances of the one or more configured paging instances (e.g., even-numbered paging frames, paging occasions, etc.). For example, in the example of FIG. 7, the device may apply the one or more PRACH adaptations and/or use the indicated PRACH configuration based on receiving the paging-related indication in the second paging frame 704B or the fourth paging frame 704D.

Additionally or alternatively, the device may apply the one or more PRACH adaptations and/or use the indicated PRACH configuration based on receiving the paging-related indication in a first half of the one or more configured paging instances (e.g., first half of paging frames, paging occasions, etc.). For example, the device may apply the one or more PRACH adaptations and/or use the indicated PRACH configuration based on receiving the paging-related indication in the first paging frame 704A or the second paging frame 704B.

In some aspects, the device may apply the one or more PRACH adaptations and/or use the indicated PRACH configuration based on receiving the paging-related indication in other paging instances than examples of the even-numbered paging instances or in the first half of paging instances as described above. For example, the device may apply the one or more PRACH adaptations and/or use the indicated PRACH configuration based on receiving the paging-related indication in odd-numbered paging instances (e.g., the first paging frame 704A or the third paging frame 704C), in a second half of paging instances (e.g., the third paging frame 704C or the fourth paging frame 704D), in middle paging instances (e.g., the second paging frame 704B or the third paging frame 704C), in outside paging instances (e.g., the first paging frame 704A or the fourth paging frame 704D), in a single paging instance, in another subgroup of the paging instances (e.g., an indicated three (3) paging frames of the four (4) configured paging frames for the DRX cycle 706), in any of the paging instances, or another option not expressly listed herein.

Additionally, while four (4) paging frames 704 are shown configured for the DRX cycle 706, the DRX cycle 706 may be configured with more or fewer paging frames 704 than four (4), and the network entity may indicate the certain paging instance(s) from the more or fewer paging frames.

### Example Operations of Entities in a Communications Network for Implicitly Indicating PRACH Adaptation

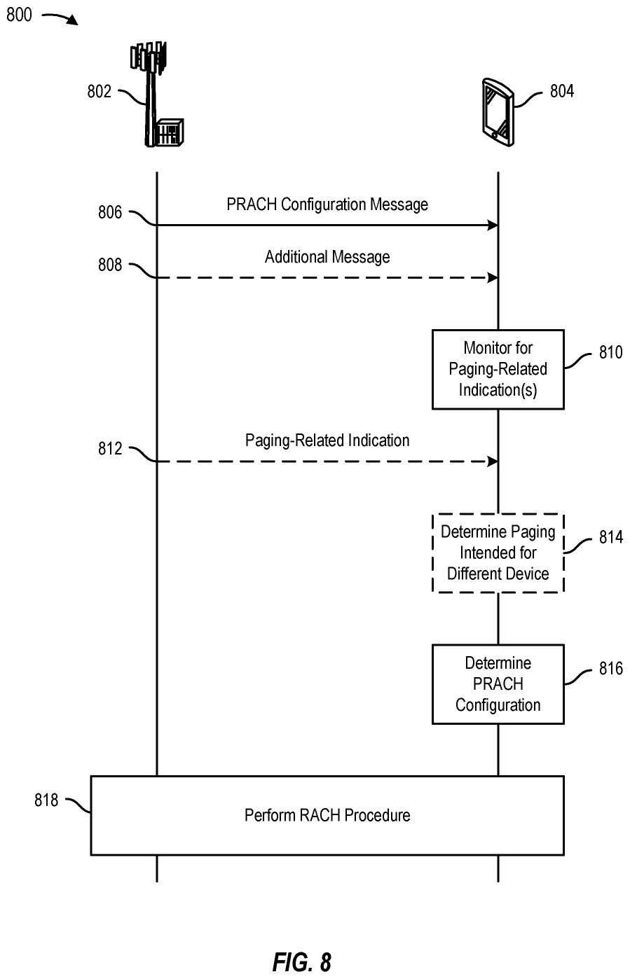

FIG. 8 depicts a process flow 800 for communications in a network between a network entity 802 and a device 804 with an indication of an activation state for PRACH adaptation in accordance with aspects of the present disclosure. In some aspects, the process flow 800 may implement aspects of or may be implemented by aspects of FIGS. 1-7. For example, the process flow 800 may include a network entity 802 and at least one device 804, where the network entity 802 may represent a base station or similar network entity as described with reference to FIGS. 1-3, 5-7, and 12 (e.g., BS 102, BS 180, network entity 502, communications device 1200, etc.) and the device 804 may represent a UE or similar terminal device as described with reference to FIGS. 1-3, 5-7, and 11 (e.g., UE 104, device 504, communications device 1100, etc.).

In the following description of the process flow 800, the operations between the network entity 802 and the device 804 may be performed in different orders or at different times. Certain operations may also be left out of the process flow 800, or other operations may be added to the process flow 800. It is to be understood that while the network entity 802 and the device 804 are shown performing a number of the operations of the process flow 800, any wireless device may perform the operations shown.

At 806, the device 804 may receive, from a network entity 802, a message that includes at least a PRACH configuration, where the PRACH configuration includes a set of parameters for performing RACH procedures to establish connectivity with the network entity 802. In some aspects, the message may be a system information message (e.g., SIB, SIB1, etc.) or an RRC message. In some aspects, the message may include an additional PRACH configuration, where the additional PRACH configuration may include an adaptation PRACH configuration as described herein. Additionally or alternatively, the device 804 may determine the adaptation PRACH configuration from the PRACH configuration. For example, the device 804 may receive the additional message including an indication of one or more adaptations for the PRACH configuration and may apply the one or more adaptations to the PRACH configuration to determine the adaptation PRACH configuration.

In some aspects, the PRACH configuration and the adaptation PRACH configuration differ by one or more parameters, such as a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

At 808, the device 804 may receive, from the network entity 802, an additional message, where the additional message comprises an authorization for the device 804 to use the adaptation PRACH configuration. Additionally or alternatively, the device 804 may receive, from the network entity 802, the additional message including an indication of the subset of the one or more configured paging instance. For example, the subset of the one or more configured paging instances may include a subset of paging occasions, a subset of paging frames, a subgroup of the one or more configured paging instances, a subset of beamformed transmissions that comprise the one or more configured paging instances, or a combination thereof. In some aspects, the additional message may include a system information message or an RRC configuration message.

At 810, the device 804 may monitor for one or more paging-related indications, from the network entity 802, in one or more configured paging instances. In some aspects, the paging-related indication may include a paging message, a paging message with certain contents, a paging early indication message, and/or a PEI indicating a paging message.

At 812, the network entity 802 may send a paging-related indication to indicate for the device 804 to use the PRACH configuration or the adaptation PRACH configuration.

At 814, the device 804 may determine the paging-related indication is intended for a different device than the apparatus.

At 816, the device 804 may determine to use the PRACH configuration or the adaptation PRACH configuration based on whether a paging-related indication is received at 812.

At 818, the device 804 and the network entity 802 may perform a RACH procedure to establish connectivity with the network entity using the PRACH configuration or the adaptation PRACH configuration. In some aspects, the device 804 may receive the paging-related indication in a paging instance of the one or more configured paging instances (e.g., at 812) and may perform the RACH procedure using the adaptation PRACH configuration based on receiving the paging-related indication. Additionally or alternatively, the device 804 may receive paging-related indication (e.g., at 812) and may perform the RACH procedure using the PRACH configuration based at least in part on receiving the paging-related indication.

In some aspects, the device 804 and the network entity may perform the RACH procedure using the adaptation PRACH configuration based on a capability of the device 804. Additionally or alternatively, the device 804 may perform the RACH procedure using the adaptation PRACH configuration based on receiving the additional message comprising the authorization (e.g., at 808). In some aspects, the device 804 may perform the RACH procedure using the adaptation PRACH configuration based on receiving the paging-related indication (e.g., at 812) in a subset of the one or more configured paging instances (e.g., received at 808).

If the device 804 determines the paging-related indication is intended for a different device (e.g., at 814), the device 804 may perform the RACH procedure using the PRACH configuration based on the paging-related indication being intended for the different device. Additionally or alternatively, the device 804 may perform the RACH procedure using the adaptation PRACH configuration based on the paging-related indication being intended for the different device and a condition. For example, the condition may include a device-type of the device 804, a capability of the device 804, characteristics of uplink traffic to be sent by the device 804, or a combination thereof.

### Example Operations of a User Equipment

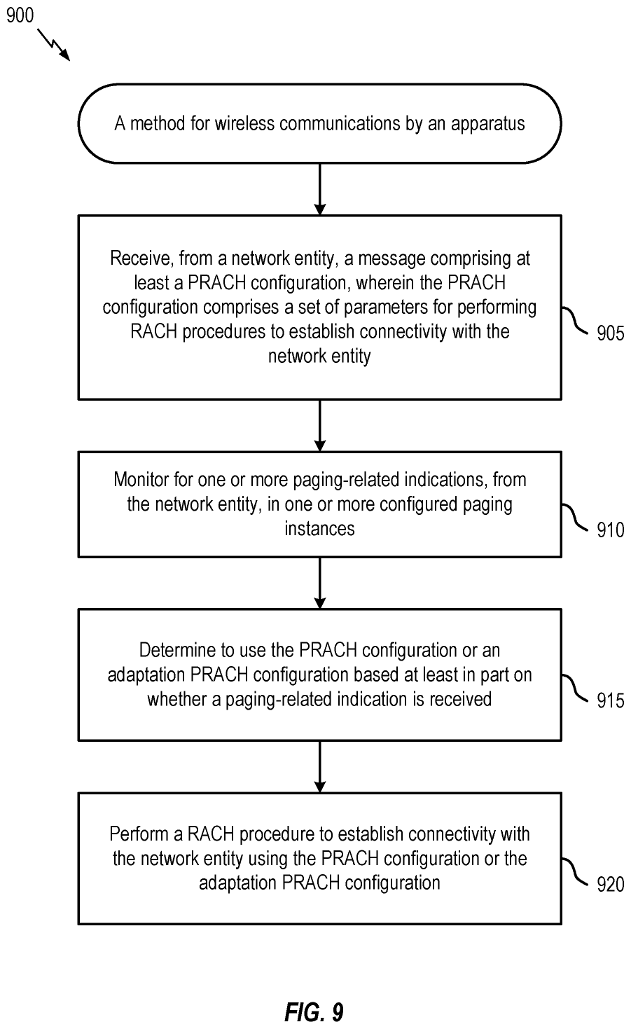

FIG. 9 shows a method 900 for wireless communications by an apparatus, such as UE 104 of FIGS. 1 and 3.

Method 900 begins at block 905 with receiving, from a network entity, a message comprising at least a PRACH configuration, wherein the PRACH configuration comprises a set of parameters for performing RACH procedures to establish connectivity with the network entity.

Method 900 then proceeds to block 910 with monitoring for one or more paging-related indications, from the network entity, in one or more configured paging instances.

Method 900 then proceeds to block 915 with determining to use the PRACH configuration or an adaptation PRACH configuration based at least in part on whether a paging-related indication is received.

Method 900 then proceeds to block 920 with performing a RACH procedure to establish connectivity with the network entity using the PRACH configuration or the adaptation PRACH configuration.

In certain aspects, method 900 further includes receiving the paging-related indication in a paging instance of the one or more configured paging instances.

In certain aspects, method 900 further includes performing the RACH procedure using the adaptation PRACH configuration based at least in part on receiving the paging-related indication.

In certain aspects, method 900 further includes receiving the paging-related indication in a paging instance of the one or more configured paging instances.

In certain aspects, method 900 further includes performing the RACH procedure using the PRACH configuration based at least in part on receiving the paging-related indication.

In certain aspects, method 900 further includes performing the RACH procedure using the adaptation PRACH configuration based at least in part on a capability of the apparatus.

In certain aspects, method 900 further includes receiving, from the network entity, an additional message, wherein the additional message comprises an authorization for the apparatus to use the adaptation PRACH configuration.

In certain aspects, method 900 further includes performing the RACH procedure using the adaptation PRACH configuration based at least in part on receiving the additional message comprising the authorization.

In certain aspects, the additional message comprises one or more of: a system information message or a RRC configuration message.

In certain aspects, method 900 further includes receiving, from the network entity, the paging-related indication in a subset of the one or more configured paging instances.

In certain aspects, method 900 further includes performing the RACH procedure using the adaptation PRACH configuration based at least in part on receiving the paging-related indication in the subset.

In certain aspects, method 900 further includes receiving, from the network entity, an additional message comprising an indication of the subset of the one or more configured paging instances, and the additional message comprises a system information message, a RRC configuration message, or a combination thereof.

In certain aspects, the subset of the one or more configured paging instances comprises a subset of paging occasions, a subset of paging frames, a subgroup of the one or more configured paging instances, a subset of beamformed transmissions that comprise the one or more configured paging instances, or a combination thereof.

In certain aspects, method 900 further includes receiving the paging-related indication in a paging instance of the one or more configured paging instances.

In certain aspects, method 900 further includes determining the paging-related indication is intended for a different device than the apparatus.

In certain aspects, method 900 further includes performing the RACH procedure using the PRACH configuration based at least in part on the paging-related indication being intended for the different device.

In certain aspects, method 900 further includes receiving the paging-related indication in a paging instance of the one or more configured paging instances.

In certain aspects, method 900 further includes determining the paging-related indication is intended for a different device than the apparatus.

In certain aspects, method 900 further includes performing the RACH procedure using the adaptation PRACH configuration based at least in part on the paging-related indication being intended for the different device and a condition.

In certain aspects, the condition comprises a device-type of the apparatus, a capability of the apparatus, characteristics of uplink traffic to be sent by the apparatus, or a combination thereof.

In certain aspects, the message comprises the PRACH configuration and an additional PRACH configuration, where the additional PRACH configuration comprises the adaptation PRACH configuration.

In certain aspects, the message comprises the PRACH configuration; and the method 900 further comprises determining the adaptation PRACH configuration from the PRACH configuration.

In certain aspects, method 900 further includes receiving an additional message, from the network entity, comprising an indication of one or more adaptations to the PRACH configuration.

In certain aspects, method 900 further includes applying the one or more adaptations to the PRACH configuration to determine the adaptation PRACH configuration.

In certain aspects, the PRACH configuration and the adaptation PRACH configuration differ by one or more parameters; and the one or more parameters comprise a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

In certain aspects, the message comprising the at least PRACH configuration comprises one or more of: a system information message or a RRC message.

In certain aspects, method 900 may be performed by the apparatus to realize one or more technical effects or solutions to the aforementioned technical problem(s). For example, based on method 900, the apparatus may save energy by implicitly adapting a PRACH configuration based on whether a paging-related indication is received, such that the apparatus uses less processing power to receive and decode the paging-related indication rather than receiving and decoding signals with higher complexity to determine a PRACH adaptation to apply. Additionally or alternatively, the apparatus may increase a reliability of communications with a network entity based on performing RACH procedures with adapted PRACH configurations, such as more ROs, to increase a likelihood the RACH procedures are successful.

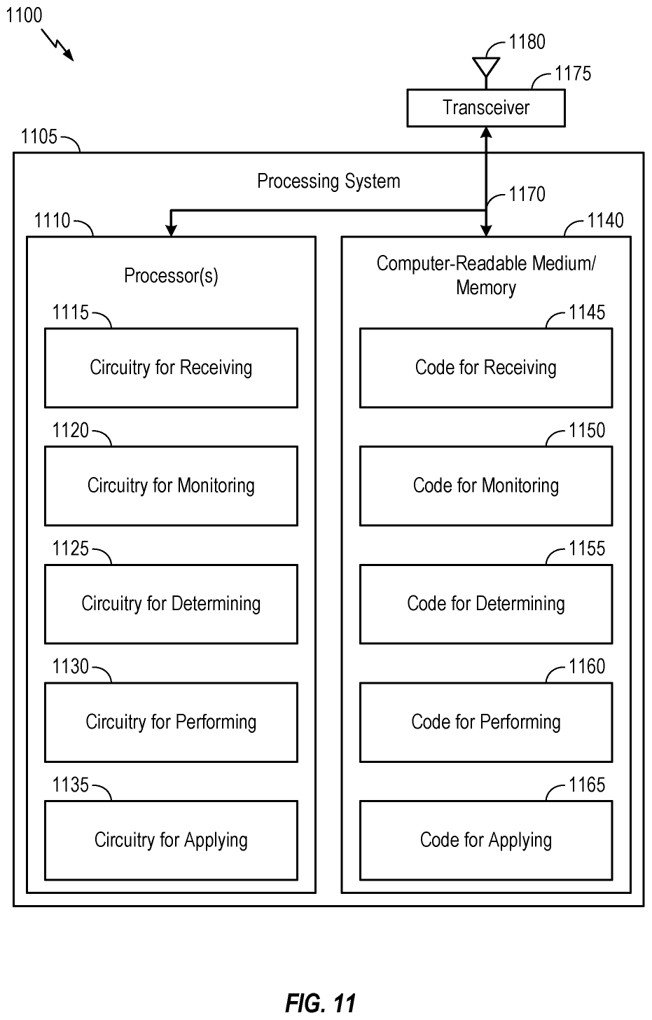

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a Network Entity

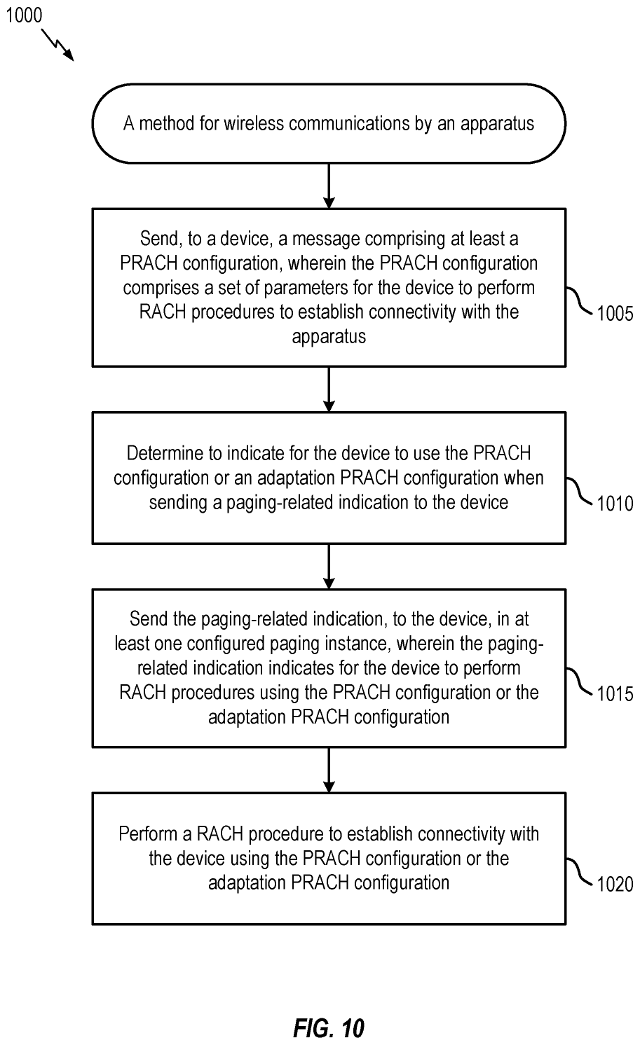

FIG. 10 shows a method 1000 for wireless communications by an apparatus, such as BS 102 of FIGS. 1 and 3, or a disaggregated base station as discussed with respect to FIG. 2.

Method 1000 begins at block 1005 with sending, to a device, a message comprising at least a PRACH configuration, wherein the PRACH configuration comprises a set of parameters for the device to perform RACH procedures to establish connectivity with the apparatus.

Method 1000 then proceeds to block 1010 with determining to indicate for the device to use the PRACH configuration or an adaptation PRACH configuration when sending a paging-related indication to the device.

Method 1000 then proceeds to block 1015 with sending the paging-related indication, to the device, in at least one configured paging instance of one or more configured paging instances, wherein the paging-related indication indicates for the device to perform RACH procedures using the PRACH configuration or the adaptation PRACH configuration.

Method 1000 then proceeds to block 1020 with performing a RACH procedure to establish connectivity with the device using the PRACH configuration or the adaptation PRACH configuration.

In certain aspects, method 1000 further includes determining to indicate for the device to use the adaptation PRACH configuration when sending the paging-related indication to the device.

In certain aspects, method 1000 further includes sending the paging-related indication in a paging instance of the one or more configured paging instances.

In certain aspects, method 1000 further includes performing the RACH procedure using the adaptation PRACH configuration based at least in part on sending the paging-related indication.

In certain aspects, method 1000 further includes determining to indicate for the device to use the PRACH configuration when sending the paging-related indication to the device.

In certain aspects, method 1000 further includes sending the paging-related indication in a paging instance of the one or more configured paging instances.

In certain aspects, method 1000 further includes performing the RACH procedure using the PRACH configuration based at least in part on sending the paging-related indication.

In certain aspects, method 1000 further includes performing the RACH procedure using the adaptation PRACH configuration based at least in part on a capability of the device.

In certain aspects, method 1000 further includes sending, to the device, an additional message, wherein the additional message comprises an authorization for the device to use the adaptation PRACH configuration.

In certain aspects, method 1000 further includes performing the RACH procedure using the adaptation PRACH configuration based at least in part on sending the additional message comprising the authorization.

In certain aspects, the additional message comprises one or more of: a system information message or a RRC configuration message.

In certain aspects, method 1000 further includes sending, to the device, the paging-related indication in a subset of the one or more configured paging instances.

In certain aspects, method 1000 further includes performing the RACH procedure using the adaptation PRACH configuration based at least in part on sending the paging-related indication in the subset.

In certain aspects, method 1000 further includes sending, to the device, an additional message comprising an indication of the subset of the one or more configured paging instances, and the additional message comprises a system information message, a RRC configuration message, or a combination thereof.

In certain aspects, the subset of the one or more configured paging instances comprises a subset of paging occasions, a subset of paging frames, a subgroup of the one or more configured paging instances, a subset of beamformed transmissions that comprise the one or more configured paging instances, or a combination thereof.

In certain aspects, method 1000 further includes sending the paging-related indication in a paging instance of the one or more configured paging instances, wherein the paging-related indication is intended for a different device than the device.

In certain aspects, method 1000 further includes performing the RACH procedure using the PRACH configuration based at least in part on the paging-related indication being intended for the different device.

In certain aspects, method 1000 further includes sending the paging-related indication in a paging instance of the one or more configured paging instances, wherein the paging-related indication is intended for a different device than the device.

In certain aspects, method 1000 further includes performing the RACH procedure using the adaptation PRACH configuration based at least in part on the paging-related indication being intended for the different device and a condition.

In certain aspects, the condition comprises a type of the device, a capability of the device, characteristics of uplink traffic to be sent by the device, or a combination thereof.

In certain aspects, the message comprises the PRACH configuration and an additional PRACH configuration, where the additional PRACH configuration comprises the adaptation PRACH configuration.

In certain aspects, the message comprises the PRACH configuration; and the method 1000 further comprises sending an additional message, to the device, comprising an indication of one or more adaptations to the PRACH configuration, the adaptation PRACH configuration comprises at least one adaptation of the one or more adaptations being applied to the PRACH configuration.

In certain aspects, the PRACH configuration and the adaptation PRACH configuration differ by one or more parameters; and the one or more parameters comprise a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

In certain aspects, the message comprising the at least PRACH configuration comprises one or more of: a system information message or a RRC message.

In certain aspects, method 1000 may be performed by the apparatus to realize one or more technical effects or solutions to the aforementioned technical problem(s). For example, based on method 1000, the apparatus may save energy and/or reduce power consumption by indicating for a device to apply one or more PRACH adaptations based on sending a paging-related indication to the device rather than sending one or more downlink messages that explicitly indicate the one or more PRACH adaptations. Additionally, based on method 1000, the apparatus may save energy by dynamically adapting PRACH configurations to reduce signaling overhead (e.g., reducing and/or muting one or more of ROs). Additionally or alternatively, based on method 1000, the apparatus may increase reliability for communications by dynamically adapting PRACH configurations to increase a number of available ROs (e.g., when more RACH attempts are expected, such as when sending a paging-related indication and/or paging message), where increasing the number of ROs may increase a likelihood that the devices can successfully perform respective RACH procedures.

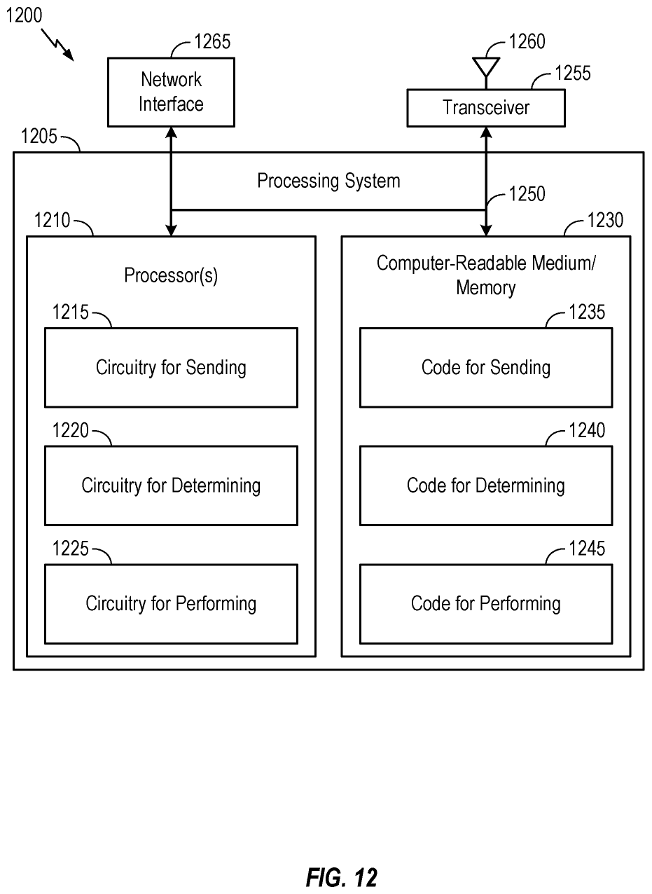

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1175 (e.g., a transmitter and/or a receiver). The transceiver 1175 is configured to transmit and receive signals for the communications device 1100 via an antenna 1180, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1140 via a bus 1170. In certain aspects, the computer-readable medium/memory 1140 is configured to store instructions (e.g., computer-executable code) that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1140 stores code for receiving 1145, code for monitoring 1150, code for determining 1155, code for performing 1160, and code for applying 1165. Processing of the code 1145-1165 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1140, including circuitry for receiving 1115, circuitry for monitoring 1120, circuitry for determining 1125, circuitry for performing 1130, and circuitry for applying 1135. Processing with circuitry 1115-1135 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1175 and/or antenna 1180 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1175 and/or antenna 1180 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1230 stores code for sending 1235, code for determining 1240, and code for performing 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for determining 1220, and circuitry for performing 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12.

### Example Clauses

Implementation examples are described in the following numbered clauses:

Clause 1: A method for wireless communications by an apparatus comprising: receiving, from a network entity, a message comprising at least a PRACH configuration, wherein the PRACH configuration comprises a set of parameters for performing RACH procedures to establish connectivity with the network entity; monitoring for one or more paging-related indications, from the network entity, in one or more configured paging instances; determining to use the PRACH configuration or an adaptation PRACH configuration based at least in part on whether a paging-related indication is received; and performing a RACH procedure to establish connectivity with the network entity using the PRACH configuration or the adaptation PRACH configuration.

Clause 2: The method of Clause 1, further comprising: receiving the paging-related indication in a paging instance of the one or more configured paging instances; and performing the RACH procedure using the adaptation PRACH configuration based at least in part on receiving the paging-related indication.

Clause 3: The method of any one of Clauses 1-2, further comprising: receiving the paging-related indication in a paging instance of the one or more configured paging instances; and performing the RACH procedure using the PRACH configuration based at least in part on receiving the paging-related indication.

Clause 4: The method of any one of Clauses 1-3, further comprising performing the RACH procedure using the adaptation PRACH configuration based at least in part on a capability of the apparatus.

Clause 5: The method of any one of Clauses 1-4, further comprising: receiving, from the network entity, an additional message, wherein the additional message comprises an authorization for the apparatus to use the adaptation PRACH configuration; and performing the RACH procedure using the adaptation PRACH configuration based at least in part on receiving the additional message comprising the authorization.

Clause 6: The method of Clause 5, wherein the additional message comprises one or more of: a system information message or a RRC configuration message.

Clause 7: The method of any one of Clauses 1-6, further comprising: receiving, from the network entity, the paging-related indication in a subset of the one or more configured paging instances; and performing the RACH procedure using the adaptation PRACH configuration based at least in part on receiving the paging-related indication in the subset.

Clause 8: The method of Clause 7, further comprising receiving, from the network entity, an additional message comprising an indication of the subset of the one or more configured paging instances, and the additional message comprises a system information message, a RRC configuration message, or a combination thereof.

Clause 9: The method of Clause 7, wherein the subset of the one or more configured paging instances comprises a subset of paging occasions, a subset of paging frames, a subgroup of the one or more configured paging instances, a subset of beamformed transmissions that comprise the one or more configured paging instances, or a combination thereof.

Clause 10: The method of any one of Clauses 1-9, further comprising: receiving the paging-related indication in a paging instance of the one or more configured paging instances; determining the paging-related indication is intended for a different device than the apparatus; and performing the RACH procedure using the PRACH configuration based at least in part on the paging-related indication being intended for the different device.

Clause 11: The method of any one of Clauses 1-10, further comprising: receiving the paging-related indication in a paging instance of the one or more configured paging instances; determining the paging-related indication is intended for a different device than the apparatus; and performing the RACH procedure using the adaptation PRACH configuration based at least in part on the paging-related indication being intended for the different device and a condition.

Clause 12: The method of Clause 11, wherein the condition comprises a device-type of the apparatus, a capability of the apparatus, characteristics of uplink traffic to be sent by the apparatus, or a combination thereof.

Clause 13: The method of any one of Clauses 1-12, wherein the message comprises the PRACH configuration and an additional PRACH configuration, wherein the additional PRACH configuration comprises the adaptation PRACH configuration.

Clause 14: The method of any one of Clauses 1-13, wherein: the message comprises the PRACH configuration; and the method further comprises determining the adaptation PRACH configuration from the PRACH configuration.

Clause 15: The method of Clause 14, further comprising: receiving an additional message, from the network entity, comprising an indication of one or more adaptations to the PRACH configuration; and applying the one or more adaptations to the PRACH configuration to determine the adaptation PRACH configuration.

Clause 16: The method of any one of Clauses 1-15, wherein: the PRACH configuration and the adaptation PRACH configuration differ by one or more parameters; and the one or more parameters comprise a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

Clause 17: The method of any one of Clauses 1-16, wherein the message comprising the at least PRACH configuration comprises one or more of: a system information message or a RRC message.

Clause 18: A method for wireless communications by an apparatus comprising: sending, to a device, a message comprising at least a PRACH configuration, wherein the PRACH configuration comprises a set of parameters for the device to perform RACH procedures to establish connectivity with the apparatus; determining to indicate for the device to use the PRACH configuration or an adaptation PRACH configuration when sending a paging-related indication to the device; sending the paging-related indication, to the device, in at least one configured paging instance of one or more configured paging instances, wherein the paging-related indication indicates for the device to perform RACH procedures using the PRACH configuration or the adaptation PRACH configuration; and performing a RACH procedure to establish connectivity with the device using the PRACH configuration or the adaptation PRACH configuration.

Clause 19: The method of Clause 18, further comprising: determining to indicate for the device to use the adaptation PRACH configuration when sending the paging-related indication to the device; sending the paging-related indication in a paging instance of the one or more configured paging instances; and performing the RACH procedure using the adaptation PRACH configuration based at least in part on sending the paging-related indication.

Clause 20: The method of any one of Clauses 18-19, further comprising: determining to indicate for the device to use the PRACH configuration when sending the paging-related indication to the device; sending the paging-related indication in a paging instance of the one or more configured paging instances; and performing the RACH procedure using the PRACH configuration based at least in part on sending the paging-related indication.

Clause 21: The method of any one of Clauses 18-20, further comprising performing the RACH procedure using the adaptation PRACH configuration based at least in part on a capability of the device.

Clause 22: The method of any one of Clauses 18-21, further comprising: sending, to the device, an additional message, wherein the additional message comprises an authorization for the device to use the adaptation PRACH configuration; and performing the RACH procedure using the adaptation PRACH configuration based at least in part on sending the additional message comprising the authorization.

Clause 23: The method of Clause 22, wherein the additional message comprises one or more of: a system information message or a RRC configuration message.

Clause 24: The method of any one of Clauses 18-23, further comprising: sending, to the device, the paging-related indication in a subset of the one or more configured paging instances; and performing the RACH procedure using the adaptation PRACH configuration based at least in part on sending the paging-related indication in the subset.

Clause 25: The method of Clause 24, further comprising sending, to the device, an additional message comprising an indication of the subset of the one or more configured paging instances, and the additional message comprises a system information message, a RRC configuration message, or a combination thereof.

Clause 26: The method of Clause 24, wherein the subset of the one or more configured paging instances comprises a subset of paging occasions, a subset of paging frames, a subgroup of the one or more configured paging instances, a subset of beamformed transmissions that comprise the one or more configured paging instances, or a combination thereof.

Clause 27: The method of any one of Clauses 18-26, further comprising: sending the paging-related indication in a paging instance of the one or more configured paging instances, wherein the paging-related indication is intended for a different device than the device; and performing the RACH procedure using the PRACH configuration based at least in part on the paging-related indication being intended for the different device.

Clause 28: The method of any one of Clauses 18-27, further comprising: sending the paging-related indication in a paging instance of the one or more configured paging instances, wherein the paging-related indication is intended for a different device than the device; and performing the RACH procedure using the adaptation PRACH configuration based at least in part on the paging-related indication being intended for the different device and a condition.

Clause 29: The method of Clause 28, wherein the condition comprises a type of the device, a capability of the device, characteristics of uplink traffic to be sent by the device, or a combination thereof.

Clause 30: The method of any one of Clauses 18-29, wherein the message comprises the PRACH configuration and an additional PRACH configuration, wherein the additional PRACH configuration comprises the adaptation PRACH configuration.

Clause 31: The method of any one of Clauses 18-30, wherein: the message comprises the PRACH configuration; and the method further comprises sending an additional message, to the device, comprising an indication of one or more adaptations to the PRACH configuration, the adaptation PRACH configuration comprises at least one adaptation of the one or more adaptations being applied to the PRACH configuration.

Clause 32: The method of any one of Clauses 18-31, wherein: the PRACH configuration and the adaptation PRACH configuration differ by one or more parameters; and the one or more parameters comprise a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

Clause 33: The method of any one of Clauses 18-32, wherein the message comprising the at least PRACH configuration comprises one or more of: a system information message or a RRC message.

Clause 34: One or more apparatuses, comprising: one or more memories comprising executable instructions; and one or more processors configured to execute the executable instructions and cause the one or more apparatuses to perform a method in accordance with any one of Clauses 1-33.

Clause 35: One or more apparatuses, comprising: one or more memories; and one or more processors, coupled to the one or more memories, configured to cause the one or more apparatuses to perform a method in accordance with any one of Clauses 1-33.

Clause 36: One or more apparatuses, comprising: one or more memories; and one or more processors, coupled to the one or more memories, configured to perform a method in accordance with any one of Clauses 1-33.

Clause 37: One or more apparatuses, comprising means for performing a method in accordance with any one of Clauses 1-33.

Clause 38: One or more non-transitory computer-readable media comprising executable instructions that, when executed by one or more processors of one or more apparatuses, cause the one or more apparatuses to perform a method in accordance with any one of Clauses 1-33.

Clause 39: One or more computer program products embodied on one or more computer-readable storage media comprising code for performing a method in accordance with any one of Clauses 1-33.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: one or more memories; and one or more processors couples to the one or more memories and configured to cause the apparatus to:
receive, from a network entity, a message comprising at least a physical random access channel (PRACH) configuration, wherein the PRACH configuration comprises a set of parameters for performing random access channel (RACH) procedures to establish connectivity with the network entity;
monitor for one or more paging-related indications, from the network entity, in one or more configured paging instances;
determine to use the PRACH configuration or an adaptation PRACH configuration based at least in part on whether a paging-related indication is received; and
perform a RACH procedure to establish connectivity with the network entity using the PRACH configuration or the adaptation PRACH configuration.

2. The apparatus of claim 1, wherein the one or more processors are configured to cause the apparatus to:
receive the paging-related indication in a paging instance of the one or more configured paging instances; and
perform the RACH procedure using the adaptation PRACH configuration based at least in part on receiving the paging-related indication.

3. The apparatus of claim 1, wherein the one or more processors are configured to cause the apparatus to:
receive the paging-related indication in a paging instance of the one or more configured paging instances; and
perform the RACH procedure using the PRACH configuration based at least in part on receiving the paging-related indication.

4. The apparatus of claim 1, wherein the one or more processors are configured to cause the apparatus to perform the RACH procedure using the adaptation PRACH configuration based at least in part on a capability of the apparatus.

5. The apparatus of claim 1, wherein the one or more processors are configured to cause the apparatus to:
receive, from the network entity, an additional message, wherein the additional message comprises an authorization for the apparatus to use the adaptation PRACH configuration; and
perform the RACH procedure using the adaptation PRACH configuration based at least in part on receiving the additional message comprising the authorization.

6. The apparatus of claim 5, wherein the additional message comprises one or more of: a system information message or a radio resource control (RRC) configuration message.

7. The apparatus of claim 1, wherein the one or more processors are configured to cause the apparatus to:
receive, from the network entity, the paging-related indication in a subset of the one or more configured paging instances; and
perform the RACH procedure using the adaptation PRACH configuration based at least in part on receiving the paging-related indication in the subset.

8. The apparatus of claim 7, wherein:
the one or more processors are configured to cause the apparatus to receive, from the network entity, an additional message comprising an indication of the subset of the one or more configured paging instances, and
the additional message comprises a system information message, a radio resource control (RRC) configuration message, or a combination thereof.

9. The apparatus of claim 7, wherein the subset of the one or more configured paging instances comprises a subset of paging occasions, a subset of paging frames, a subgroup of the one or more configured paging instances, a subset of beamformed transmissions that comprise the one or more configured paging instances, or a combination thereof.

10. The apparatus of claim 1, wherein the one or more processors are configured to cause the apparatus to:
receive the paging-related indication in a paging instance of the one or more configured paging instances;
determine the paging-related indication is intended for a different device than the apparatus; and
perform the RACH procedure using the PRACH configuration based at least in part on the paging-related indication being intended for the different device.

11. The apparatus of claim 1, wherein the one or more processors are configured to cause the apparatus to:
receive the paging-related indication in a paging instance of the one or more configured paging instances;
determine the paging-related indication is intended for a different device than the apparatus; and
perform the RACH procedure using the adaptation PRACH configuration based at least in part on the paging-related indication being intended for the different device and a condition.

12. The apparatus of claim 11, wherein the condition comprises a device-type of the apparatus, a capability of the apparatus, characteristics of uplink traffic to be sent by the apparatus, or a combination thereof.

13. The apparatus of claim 1, wherein:
the message comprises the PRACH configuration and an additional PRACH configuration; and
the additional PRACH configuration comprises the adaptation PRACH configuration.

14. The apparatus of claim 1, wherein:
the message comprises the PRACH configuration; and
the one or more processors are configured to cause the apparatus to determine the adaptation PRACH configuration from the PRACH configuration.

15. The apparatus of claim 14, wherein the one or more processors are configured to cause the apparatus to:
receive an additional message, from the network entity, comprising an indication of one or more adaptations to the PRACH configuration; and
apply the one or more adaptations to the PRACH configuration to determine the adaptation PRACH configuration.

16. The apparatus of claim 1, wherein:
the PRACH configuration and the adaptation PRACH configuration differ by one or more parameters; and
the one or more parameters comprise a plurality of RACH occasions, a periodicity of the plurality of RACH occasions, a number of synchronization blocks per RACH occasion of the plurality of RACH occasions, a bitmap indicating one or more RACH occasions of the plurality of RACH occasions that are not to be used for RACH procedures, or a combination thereof.

17. The apparatus of claim 1, wherein the message comprising the at least PRACH configuration comprises one or more of: a system information message or a radio resource control (RRC) message.

18. An apparatus configured for wireless communications, comprising: one or more memories; and one or more processors couples to the one or more memories and configured to cause the apparatus to:
send, to a device, a message comprising at least a physical random access channel (PRACH) configuration, wherein the PRACH configuration comprises a set of parameters for the device to perform random access channel (RACH) procedures to establish connectivity with the apparatus;
determine to indicate for the device to use the PRACH configuration or an adaptation PRACH configuration when sending a paging-related indication to the device;
send the paging-related indication, to the device, in at least one configured paging instance of one or more configured paging instances, wherein the paging-related indication indicates for the device to perform RACH procedures using the PRACH configuration or the adaptation PRACH configuration; and
perform a RACH procedure to establish connectivity with the device using the PRACH configuration or the adaptation PRACH configuration.

19. The apparatus of claim 18, wherein the one or more processors are configured to cause the apparatus to:
determine to indicate for the device to use the adaptation PRACH configuration when sending the paging-related indication to the device;
send the paging-related indication in a paging instance of the one or more configured paging instances; and
perform the RACH procedure using the adaptation PRACH configuration based at least in part on sending the paging-related indication.

20. A method for wireless communications by an apparatus comprising:
receiving, from a network entity, a message comprising at least a physical random access channel (PRACH) configuration, wherein the PRACH configuration comprises a set of parameters for performing random access channel (RACH) procedures to establish connectivity with the network entity;
monitoring for one or more paging-related indications, from the network entity, in one or more configured paging instances;
determining to use the PRACH configuration or an adaptation PRACH configuration based at least in part on whether a paging-related indication is received; and
performing a RACH procedure to establish connectivity with the network entity using the PRACH configuration or the adaptation PRACH configuration.
